(19) United States
(12) Patent Application Publication
(10) Pub. No.: US 2007/0200279 A1
(43) Pub. Date: Aug. 30, 2007

(54) Circular Resin-Molded Product Having Circular Center Hole And Method And Apparatus For Molding The Same

(76) Inventor: Toshiya Yui, Matsudo-shi (JP)

Correspondence Address: MCGLEW & TUTTLE, PC, P.O. BOX 9227, SCARBOROUGH STATION, SCARBOROUGH, NY, 10510-9227, US

(21) Appl. No.: 10/599,648

(22) PCT Filed: Dec. 5, 2005
(86) PCT No.: PCT/JP05/22269

§ 371 Date: Oct. 4, 2006

(30) Foreign Application Priority Data
Jan. 7, 2005 (JP) 2005-001983

(51) Int. Cl. B29C 45/00

(52) U.S. Cl. 264/328.1; 425/542; 425/577

(57) ABSTRACT

An annular molded product of the present invention is molded by means of injecting a molten resin into a mold through an injection gate and cooling and solidifying the injected molten resin. The annular molded product is formed in the mold around a center pin having a diameter equivalent to the diameter of the circular center hole. The center pin axially extends further away from a position corresponding to the circular resin-molded product, whereby the injection gate is constituted by a tubular channel formed by a cylindrical annular clearance formed within the mold around an extended portion of the center pin. An annular gate trace is formed on the front or back surface of the annular molded product in such a manner as to project in an axial direction of the annular molded product.

### TECHNICAL FIELD

The present invention relates to a circular resin-molded product having a circular center hole which is molded by means of injecting a molten resin into a mold through an injection gate and cooling and solidifying the injected molten resin, as well as to a method and apparatus for molding the circular resin-molded product.

### BACKGROUND ART

Gears and turntables of resin are formed by injection molding. In injection molding, a resin material which is melted by application of heat is injected into a mold, and the injected, molten resin is cooled and solidified, thereby yielding a molded product. In the case where such a molded product assumes a circular shape having a circular center hole (i.e., an annular shape) as in the case of gears and turntables, the molded product must have good roundness and surface flatness.

Conventionally, in the case where such a molded product having an annular shape is to be formed from resin, in order to improve roundness, a multiple-gate configuration has been employed. In the multiple-gate configuration, resin is injected through a plurality of gates. FIG. 16 is a pair of schematic views for explaining injection of resin through six gates, wherein (A) is a plan view, and (B) is a vertical sectional view. Simultaneous injection through a plurality of gates arranged on a concentric circle can improve roundness of a molded product having an annular shape. FIG. 17(A) is a graph showing measurements of roundness in injection of a glass-containing resin through six gates, and FIG. 17(B) is a graph showing measurements of roundness in injection of the glass-containing resin through eight gates.

Injection through multiple gates generally improves roundness. However, roundness of a molded product is influenced by a large number of weld lines which are generated in the course of injection. A weld line is a joined portion of resin where resins from different gates merge together. Particularly, in the case of use of a glass-fiber-containing resin, collision of glass fibers in a weld zone impairs roundness.

Conventionally known measures to solve the above problem associated with use of multiple gates include the following. Injection gates are divided into two groups. The two groups of injection gates are arranged on two different, concentric circles and at different phase angles (see Patent Document 1). Alternatively, not only a plurality of main gates but also subgates branching from the main gates are arranged (see Patent Document 2).

However, these techniques apparently involve a complex configuration and still have a problem of weld lines, since a molding material is injected from a plurality of gates. Also, use of multiple gates is accompanied by an increase in the number of runner portions (inlet portions extending to gates) and thus impairs yield, since resin solidified in the runner portions is discarded. Furthermore, actual manufacture constitutes not molding of a single product as illustrated but simultaneous molding of a large number of products. In this case, resin introduction pressure varies among the multiple gates depending on the direction of a resin inlet portion (direction of a runner) branching from a main resin introduction channel to each gate. As a result, uniform introduction of resin to the gates is difficult.

In order to prevent generation of weld lines, there is known an injection technique in which resin is injected from a single center gate and is caused to flow radially in the form of a film within a mold (a so-called film gate). FIG. 18 is a series of schematic views for explaining injection through such a film gate, wherein (A) is a plan view, (B) is a vertical sectional view, and (C) is a vertical sectional view showing, on an enlarged scale, an injection portion. This technique has a feature of uniform distribution of resin along a circumferential direction and thus does not cause generation of weld lines. However, since this film gate injects resin from a position corresponding to a center hole portion of a resin-molded product, at a final stage, an unnecessary portion must be cut from the resin-molded product so as to finish a center hole portion. This cutting operation involves generation of burrs on the wall surface of the center hole portion. Since the center hole portion of the completed molded product is used as, for example, a sliding guide or a mating hole for receiving a shaft, an additional step of removing the burrs is required. In the case of a molded product, such as a turntable, where a shaft is press-fitted into a circular hole thereof, presence of burrs on the wall surface of the circular hole impairs coaxiality between the shaft and the circular hole. In the case of a reduction gear which rotates in a sliding manner on a shaft inserted into a circular hole thereof, burrs on the wall surface of the circular hole increase friction between the shaft and the wall surface of the circular hole to thereby cause generation of noise, or the burrs enter a speed reducer as foreign matter.

Patent Document 1: Japanese Patent Application Laid-Open (kokai) No. 6-278163

Patent Document 2: Japanese Patent Application Laid-Open (kokai) No. 2002-292678

### DISCLOSURE OF THE INVENTION

### Problems to be Solved by the Invention

An object of the present invention is to solve the above-mentioned problems and to injection-mold a circular resin-molded product without generation of weld lines, to thereby improve roundness and surface flatness, with minimized generation of a runner portion, to thereby improve yield, and without need to employ a post-molding step of, for example, deburring.

### MEANS FOR SOLVING THE PROBLEMS

A circular resin-molded product having a circular center hole of the present invention is molded by means of injecting a molten resin into a mold through an injection gate and cooling and solidifying the injected molten resin. This circular resin-molded product is formed in the mold around a center pin having a diameter equivalent to the diameter of the circular center hole, by injecting resin from the injection gate. The center pin axially extends further away from the position corresponding to the circular resin-molded product, whereby the injection gate is constituted by a tubular channel formed by a cylindrical annular clearance formed within the mold around an extended portion of the center pin. An annular gate trace is formed on the front or back surface of the circular resin-molded product in such a manner as to project in an axial direction of the circular resin-molded product.

A method for manufacturing a circular resin-molded product having a circular center hole of the present invention molds the circular resin-molded product by means of injecting a molten resin into a mold through an injection gate and cooling and solidifying the injected molten resin. The circular resin-molded product is formed in the mold around a center pin having a diameter equivalent to the diameter of the circular center hole. The center pin axially extends further away from the position corresponding to the circular resin-molded product, whereby the injection gate is constituted by a tubular channel formed by a cylindrical annular clearance formed within the mold around an extended portion of the center pin. The molten resin is injected through the injection gate constituted by the tubular channel.

An apparatus for manufacturing a circular resin-molded product having a circular center hole uses a mold into which a molten resin is injected through an injection gate and in which the injected molten resin is cooled and solidified, thereby molding the circular resin-molded product. The mold forms the circular resin-molded product around a center pin having a diameter equivalent to the diameter of the circular center hole. The center pin axially extends further away from the position corresponding to the circular resin-molded product, whereby the injection gate is constituted by a tubular channel formed by a cylindrical annular clearance formed within the mold around an extended portion of the center pin. The molten resin is injected through the injection gate constituted by the tubular channel.

### EFFECT OF THE INVENTION

According to the present invention, an annular gate trace is formed on the surface of the circular resin-molded product in such a manner as to project in an axial direction of the circular resin-molded product. That is, no burrs are formed on the wall surface of the circular center hole. Thus, an additional step of, for example, deburring is unnecessary. A burr, which is formed in an axially projecting manner on the surface of the circular resin-molded product in a gate-cutting step, can be left as is, without raising any problem in use of the circular resin-molded product.

According to the present invention, the molten resin flows radially in a uniform manner as viewed on the same circle. Thus, basically, no weld lines are formed, thereby improving roundness and surface flatness of the circular resin-molded product.

### BRIEF DESCRIPTION OF THE DRAWINGS

FIG. 1 is a view for explaining a first embodiment of the present invention, showing a state in which a molten resin is injected into a mold.

FIG. 2 is a pair of views showing, on an enlarged scale, a sleeve gate portion of FIG. 1, wherein (A) is a sectional view of a sleeve gate taken along line X-X of (B), and (B) is a vertical sectional view.

FIG. 3 is a pair of views showing annular resin-molded products manufactured by a method of the present invention, wherein (A) shows a gear having a flat surface, and (B) shows a gear having a recess formed on a surface for reducing thickness.

FIG. 4 is a view showing a state in which a mold is opened to an initial extent.

FIG. 5 is a view showing a state in which the mold is opened to a more advanced extent, and a sleeve gate is removed.

FIG. 6 is a view showing a state in which the mold is fully opened.

FIG. 7 is a view for explaining a second embodiment of the present invention in which the diameter of a mounting hole of an annular resin-molded product is small, showing a state in which resin is injected.

FIG. 8 is a view for explaining the second embodiment, showing a state in which the sleeve gate is cut from a resin-molded product.

FIG. 9 is a graph showing measurements of roundness of a resin-molded product which is molded according to the present invention.

FIG. 10 is a view showing an annular resin-molded product manufactured by a method of the present invention different from that of FIG. 3.

FIG. 11 is a view showing a state in which a molten resin is injected into a mold for molding the annular resin-molded product shown in FIG. 10.

FIG. 12 is a pair of views showing, on an enlarged scale, a sleeve gate portion of FIG. 11, wherein (A) is a view illustrating the relation of radial positions among components and a molded product, and (B) is a vertical sectional view.

FIG. 13 is a view showing a state in which a mold Q and a mold R are opened apart from each other.

FIG. 14 is a view showing an advanced state of mold opening in which the mold Q is separated from a mold P, and a mold S is separated from the mold R.

FIG. 15 is a view for explaining a state in which the sleeve gate is separated from the mold R and is dropping.

FIG. 16 is a pair of schematic views for explaining injection of resin through six gates of a conventional technique, wherein (A) is a plan view, and (B) is a vertical sectional view.

FIG. 17 is a pair of graphs showing measurements of roundness in injection of a glass-containing resin, wherein (A) shows injection through six gates, and (B) shows injection through eight gates.

FIG. 18 is a series of views for explaining injection through a film gate of a conventional technique, wherein (A) is a plan view, (B) is a vertical sectional view, and (C) is a vertical sectional view showing, on an enlarged scale, an injection portion.

### BEST MODE FOR CARRYING OUT THE INVENTION

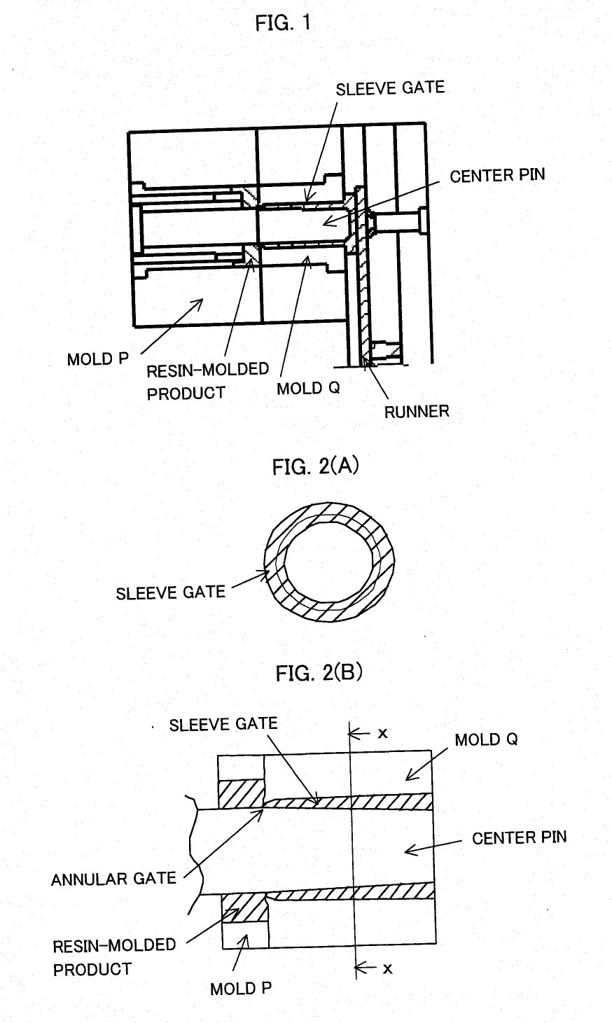

The present invention will next be described by means of embodiments. FIGS. 1 to 6 are views for explaining a first embodiment of the present invention. FIG. 1 shows a state in which a molten resin is injected into a mold for molding an annular resin-molded product having a mounting hole (a circular hole) at the center, such as a gear or a turntable. The annular resin-molded product is formed around a center pin assuming the form of a circular rod in a mold P, which can be separated from other molds when the completed annular resin-molded product is to be ejected therefrom. The diameter of the center pin is equivalent to that of the mounting hole of the completed annular resin-molded product. A sleeve gate which is a feature of the present invention and through which resin is injected for forming the annular resin-molded product is formed between the inner circumferential surface of a mold Q and the outer circumferential surface of an extended portion of the center pin extending to a position near a runner. The center pin assumes the form of a circular rod, and the inner circumferential surface of the mold Q has a circular cross section, whereby a cylindrical annular clearance is formed therebetween. The illustrated runner is a resin introduction portion extending to the sleeve gate.

FIG. 2 is a pair of views showing, on an enlarged scale, the sleeve gate portion shown in FIG. 1, wherein (A) is a sectional view of the sleeve gate taken along line X-X of (B), and (B) is a vertical sectional view. The sleeve gate of the present invention assumes a cylindrical shape having an annular (ring-like) cross section. A tip end portion of the sleeve gate projects in an axial direction of the mounting hole of the annular resin-molded product and can be in contact with the surface of the annular resin-molded product at any radial position between the inner circumference and the outer circumference of the annular resin-molded product. In the sleeve gate shown in FIG. 2, a tip end portion thereof is in contact with the surface of the annular resin-molded product at an innermost position (a position adjacent to the inner circumferential surface of the annular resin-molded product). The center pin and the tubular hole of the mold Q can be tapered such that the clearance of the sleeve gate is reduced toward the annular resin-molded product, whereby removal of a sleeve gate portion is facilitated when the annular resin-molded product is completed. For example, such a taper is desirable for a material of small shrinkage, such as polycarbonate and is particularly desirable for a resin material of large shrinkage, such as glass-containing nylon or glassless nylon. In order to allow the sleeve gate portion and the annular resin-molded product to be torn off each other at the tip end portion of the sleeve gate in a later step, the thickness of the sleeve gate portion is the smallest at the tip end portion.

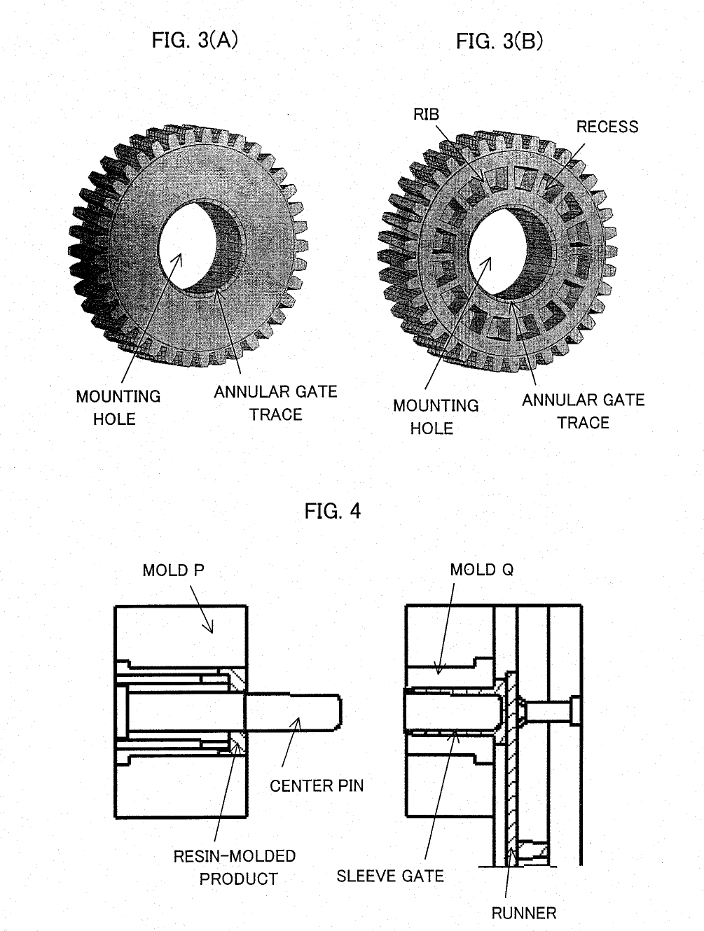

FIG. 3 is a pair of views showing annular resin-molded products manufactured by a method of the present invention, wherein (A) shows a gear having a flat surface, and (B) shows a gear having a recess formed on a surface for reducing thickness. As shown in FIG. 3(B), ribs are provided on a surface of the gear for forming thickness-reducing recesses, thereby reducing the weight of the product for lowering material cost. Since the thickness-reducing recesses do not reach an axially central portion of the annular resin-molded product, injected resin flows sufficiently uniformly in every radial direction. For ensuring uniform flow of resin, the gear shown in FIG. 3(A) is not provided with ribs and thus has a flat surface. As is apparent from the above description, in the illustrated resin-molded products, a gate trace assumes an annular shape and is formed around the mounting hole (a position adjacent to the wall surface of the mounting hole) in such a manner as to project in an axial direction of the annular resin-molded product. Thus, when the solidified sleeve gate portion is cut from the annular resin-molded product, an associated burr projects only in an axial direction of the annular resin-molded product. Therefore, merely by removing the annular resin-molded product from the mold, the wall surface of the mounting hole can be finished sufficiently smoothly without need to cut off the burr.

FIG. 4 is a view showing a state in which the mold is opened. After a molten resin injected into the unitarily closed mold is solidified, as shown in FIG. 4, the mold P is separated from the mold Q. This separation of the molds P and Q causes the annular resin-molded product and the sleeve gate portion to be torn off each other at a connection portion thereof. As mentioned above, this causes formation of an axially projecting burr on the annular resin-molded product.

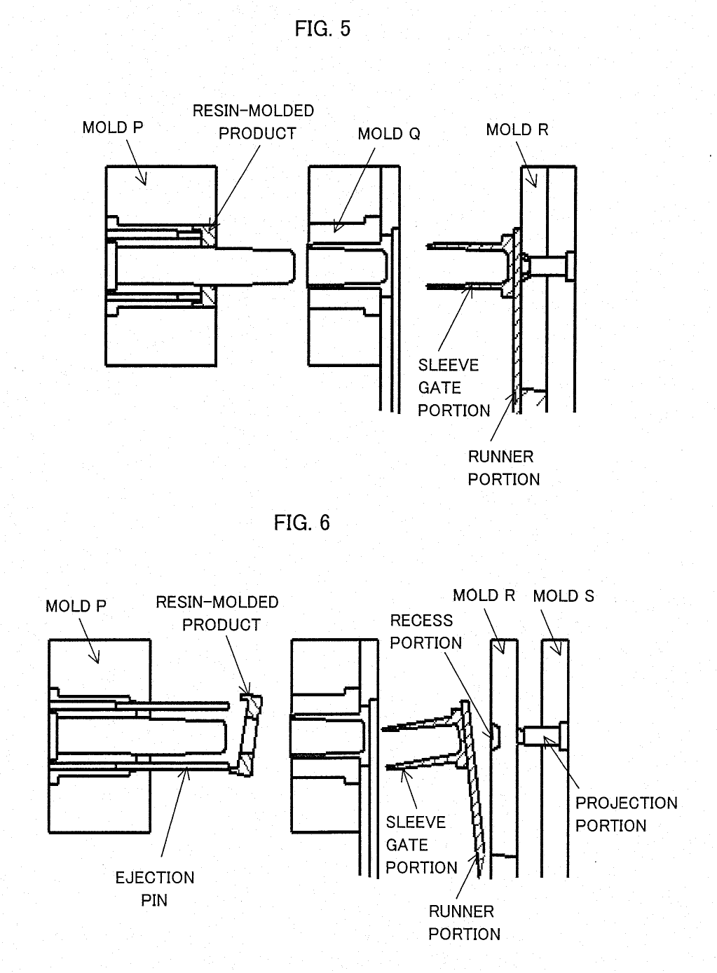

FIG. 5 is a view showing a state in which the mold is opened to a more advanced extent, and the sleeve gate portion is removed. Separation of a mold R from the mold Q causes the sleeve gate portion to be removed from inside the mold Q.

FIG. 6 is a view showing a state in which the mold is fully opened. Ejection pins are projected from the mold P, thereby separating the annular resin-molded product from the mold P. As shown in FIG. 5, when the mold R and the mold S are united together, the sleeve gate portion is attached to the mold R by resin which is present in a circular recess provided in the mold R and around a circular rod-like projection of the mold S projected into the circular recess. As shown in FIG. 6, separation of the mold R and the mold S causes the sleeve gate portion adhering to the mold R to be separated from the mold R and drop.

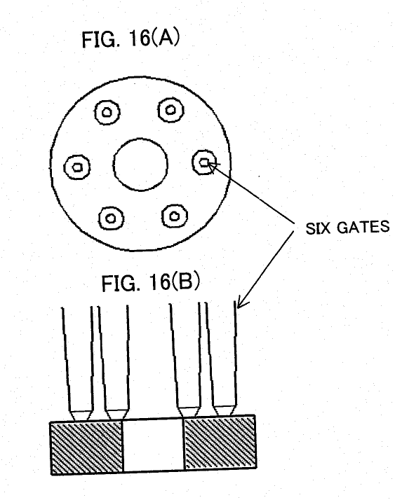

By the above-mentioned steps, the annular resin-molded product is completed. As shown in FIG. 3, a gate trace associated with the gate through which resin was injected is formed on the front or back surface of the thus-formed annular resin-molded product at a position adjacent to the wall surface of the center hole, not on the wall surface of the center hole as in the case of FIG. 16(C). The gate trace is a burr, but is located at such a position as to not raise any problem in use of the annular resin-molded product. If the burr projecting from the surface should raise a problem in use of the annular resin-molded product, a region where the gate trace is formed may be axially recessed from the surface of the product so as to solve the problem.

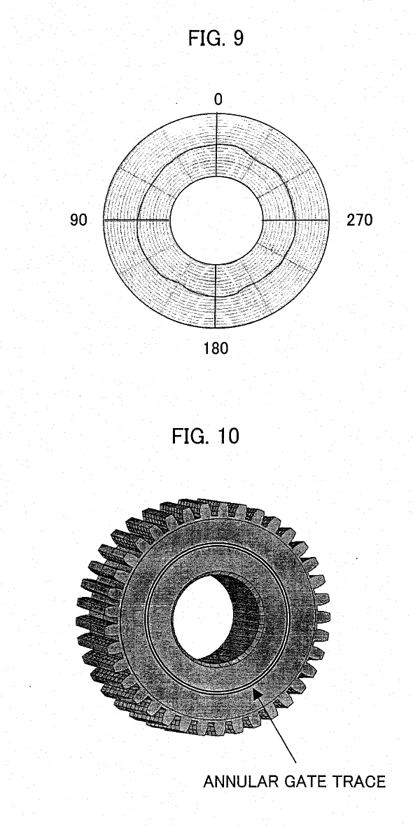

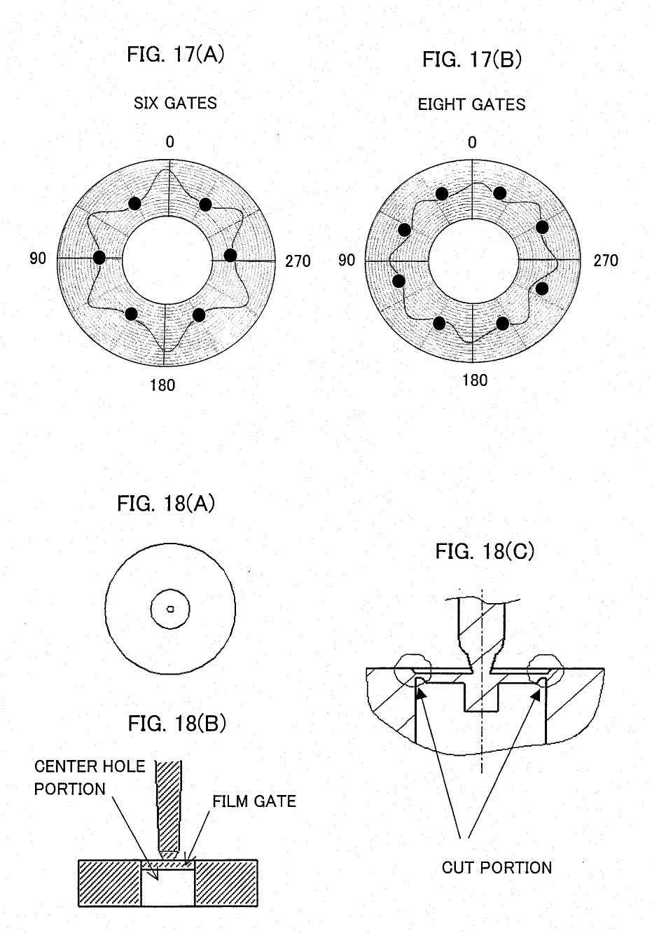

Since the gate trace is formed around the mounting hole in an annular (ring-like) form, generation of weld lines during molding can be prevented, thereby improving roundness of the annular resin-molded product. FIG. 9 is a graph showing measurements of roundness of the annular resin-molded product which is thus molded. As is apparent from FIG. 9, the annular resin-molded product of the present embodiment exhibits excellent roundness as compared with the aforementioned annular resin-molded products which are formed by injection through multiple gates shown in FIG. 17. After the annular resin-molded product is completed through cooling of an injected resin, solidified resin of a gate portion is discarded. In this connection, since only a single center gate is used, yield is improved as compared with the multiple-gate configuration.

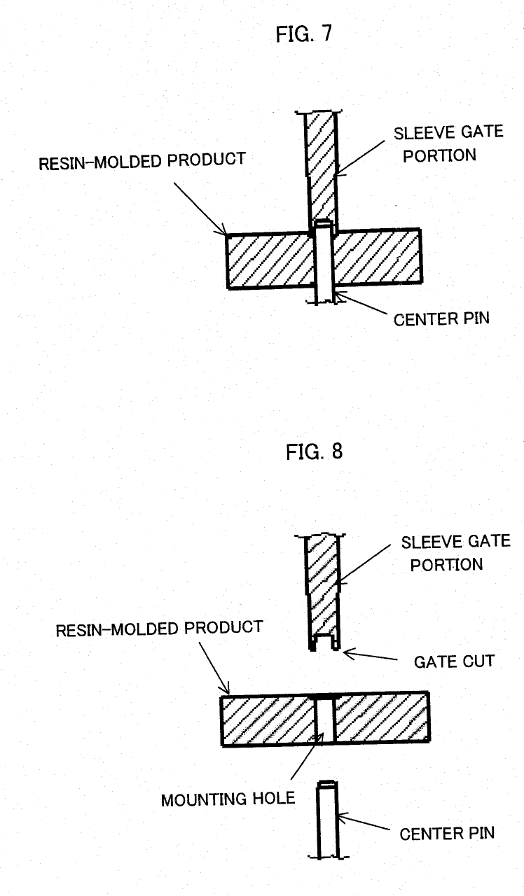

Next, a second embodiment of the present invention will be described with reference to FIGS. 7 and 8. In the second embodiment, the diameter of a mounting hole of an annular resin-molded product is small. FIGS. 7 and 8 show an injected resin and a center pin only, while illustration of a mold and other components is omitted. FIG. 7 shows a state in which resin is injected, and FIG. 8 shows a state in which a sleeve gate portion is cut from the annular resin-molded product. In the illustrated embodiment, the diameter of the mounting hole of the annular resin-molded product is small; accordingly, the diameter of the center pin is small. The present embodiment differs from the above-described first embodiment only in the shape of the sleeve gate portion. In FIG. 7, the center pin extends only into a tip end portion of the sleeve gate portion. Thus, only a tip end portion of the sleeve gate portion which is in contact with the annular resin-molded product assumes a hollow tubular shape, and the remaining portion of the sleeve gate portion assumes the form of a solid cylinder. Even in this configuration, a gate portion through which resin is injected assumes the form of an annular clearance as in the case of the first embodiment, the present embodiment functions similarly to the first embodiment.

Next, a third embodiment of the present invention will be described with reference to FIGS. 10 to 15. FIG. 10 is a view showing an annular resin-molded product manufactured by a method of the present invention different from that of FIG. 3. In the annular resin-molded product shown in FIG. 10, a gate trace not only assumes an annular shape but also is formed on a surface of the annular resin-molded product at an approximately radially central position and concentrically with a mounting hole and in such a manner as to project in an axial direction of the annular resin-molded product. Thus, as in the case of the annular resin-molded product which has been described with reference to FIG. 3, when a solidified sleeve gate portion is cut from the annular resin-molded product, a burr formed in association with the cutting action projects only in an axial direction of the annular resin-molded product. Therefore, merely by removing the annular resin-molded product from the mold, the wall surface of the mounting hole can be finished sufficiently smoothly without need to cut off the burr. In the case of the annular resin-molded product which has been described with reference to FIG. 3, since resin is injected from an inner-circumference side (a position adjacent to the inner circumferential surface) and flows toward an outer-circumference side, the inner circumferential surface of the annular resin-molded product is higher in injection pressure than the outer circumferential surface of the product, and thus the inner circumferential surface; i.e., the mounting hole, exhibits high dimensional accuracy. By contrast, as in the case of the annular resin-molded product shown in FIG. 10, resin is injected from an approximately radially central position; thus, the outer circumferential surface and the inner circumferential surface can be finished with approximately equivalent accuracy. In the case of an annular resin-molded product whose outer circumferential surface (where, for example, a gear portion is formed) is more important than the inner circumferential surface in terms of a finished condition, resin can be injected in an axial direction of the annular resin-molded product from a position biased toward the outer circumference of the annular resin-molded product. In this manner, the radial, concentric position of the sleeve gate can be determined as appropriate depending on whether the inner or outer circumferential surface of the annular resin-molded product is to be finished with higher accuracy, or the inner and outer circumferential surfaces are to be finished with equivalent accuracy. Injection from a position biased toward the inner circumferential surface is lower in material cost, since the diameter of a sleeve gate portion to be discarded is smaller. Even though a burr is formed in such a manner as to project in an axial direction of the annular resin-molded product, the burr formed in the vicinity of the mounting hole may be caught in the mounting hole by a shaft which is inserted into the mounting hole. Therefore, in some cases, injection of resin from a position located away from the inner circumference of the annular resin-molded product may be advantageous.

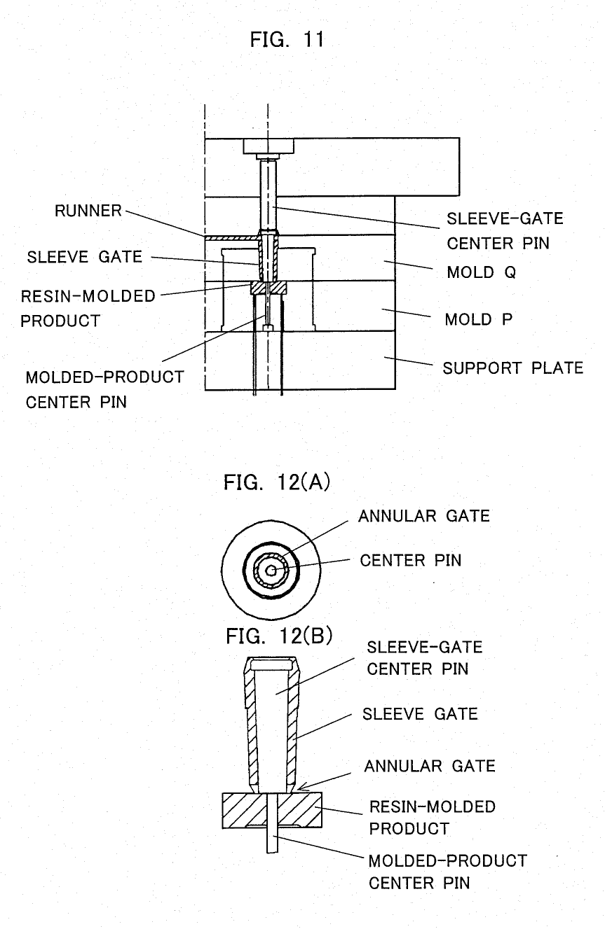

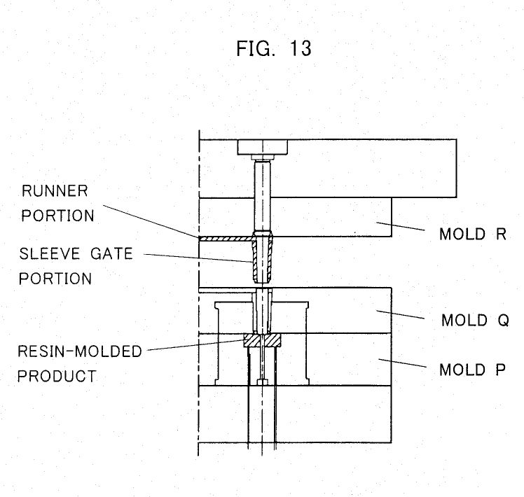

FIG. 11 is a view showing a state in which a molten resin is injected into a mold for molding the annular resin-molded product shown in FIG. 10. FIG. 12 is a pair of views showing, on an enlarged scale, a sleeve gate portion of FIG. 11, wherein (A) is a view illustrating the relation of radial positions among components and a molded product, and (B) is a vertical sectional view. The annular resin-molded product is formed around a center pin assuming the form of a circular rod in a mold P, which can be separated from other molds when the completed annular resin-molded product is to be ejected therefrom. The center pin consists of a molded-product center pin whose diameter is equivalent to the diameter of a mounting hole of the completed annular resin-molded product and is relatively small, and a sleeve-gate center pin whose diameter is greater than that of the molded-product center pin. The molded-product center pin and the sleeve-gate center pin are separated from each other. A sleeve gate which is a feature of the present invention and through which resin is injected for forming the annular resin-molded product is formed between the inner circumferential surface of a mold Q and the outer circumferential surface of the sleeve-gate center pin. The sleeve-gate center pin assumes the form of a circular rod, and the inner circumferential surface of the mold Q has a circular cross section, whereby a cylindrical annular clearance is formed therebetween. The lower end surface of the sleeve-gate center pin and the upper end surface of the molded-product center pin abut each other at a position of the upper surface of the annular resin-molded product. The illustrated runner is a resin introduction portion extending to the sleeve gate.

FIG. 13 is a view showing a state in which the mold Q and a mold R are opened apart from each other. After a molten resin injected into the unitarily closed mold is solidified, as shown in FIG. 13, the mold R is separated from the mold Q. This separation of the molds R and Q causes the annular resin-molded product and the sleeve gate portion to be torn off each other at a connection portion thereof. As mentioned above, this causes formation of only an axially projecting burr on the annular resin-molded product.

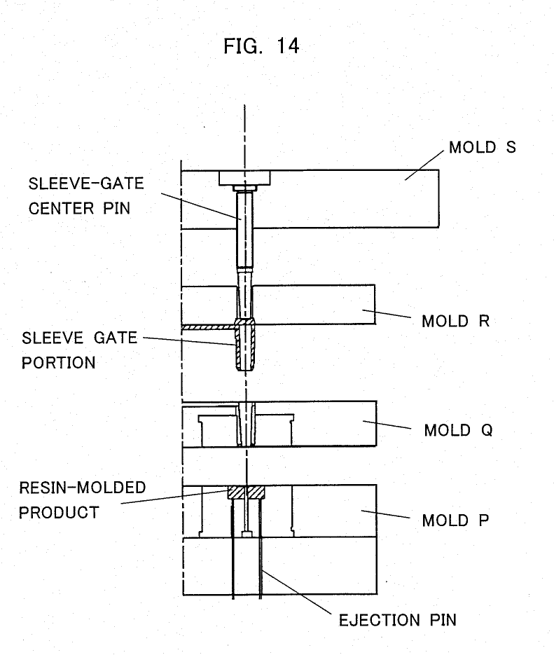

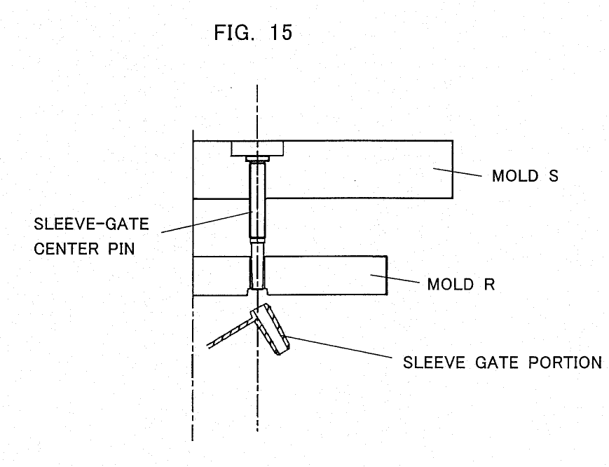

FIG. 14 is a view showing an advanced state of mold opening in which the mold Q is separated from a mold P, and a mold S is separated from the mold R. Ejection pins are projected from the mold P, thereby separating the annular resin-molded product from the mold P.

As shown in FIG. 15, separation of the mold R and the mold S causes the sleeve gate adhering to the mold R to be separated from the mold R and drop.

By the above-mentioned steps, the annular resin-molded product is completed. A gate trace associated with the gate through which resin was injected is formed on the front or back surface of the annular resin-molded product at a position which is radially biased toward the outer circumference of the annular resin-molded product from an innermost position (a position adjacent to the inner circumferential surface of the annular resin-molded product). The gate trace is a burr, but is located at such a position as to not raise any problem in use of the annular resin-molded product.

1. A circular resin-molded product having a circular center hole which is molded by means of injecting a molten resin into a mold through an injection gate and cooling and solidifying the injected molten resin,
the molten resin being injected into the mold through the injection gate formed by a cylindrical tubular channel, and
an annular gate trace being formed on a front or back surface of the circular resin-molded product at a radially predetermined position in such a manner as to project in an axial direction of the circular resin-molded product.

2. A circular resin-molded product according to claim 1, wherein the annular gate trace projecting in an axial direction of the circular resin-molded product is formed at a position adjacent to the circular center hole, at a position in the vicinity of an outer circumference of the circular resin-molded product, or at a radially central position.

3. A circular resin-molded product having a circular center hole according to claim 1, wherein the front and rear surfaces of the circular resin-molded product are generally flat without a thickness-reducing recess being formed thereon.

4. A method for manufacturing a circular resin-molded product having a circular center hole by means of injecting a molten resin into a mold through an injection gate and cooling and solidifying the injected molten resin, the method comprising steps of:
forming the circular resin-molded product in the mold around a center pin having a diameter equivalent to a diameter of the circular center hole;
extending the center pin axially further away from a position corresponding to the circular resin-molded product, whereby the injection gate is constituted by a tubular channel formed by a cylindrical annular clearance formed within the mold around an extended portion of the center pin; and
injecting the molten resin through the injection gate constituted by the tubular channel.

5. A method for manufacturing a circular resin-molded product according to claim 4, wherein the clearance of the injection gate is reduced toward the circular resin-molded product and is the smallest at a tip end portion in contact with the circular resin-molded product.

6. A method for manufacturing a circular resin-molded product according to claim 4, wherein the center pin extends to a position near a runner portion through which the molten resin is introduced into the injection gate, so that the entire injection gate has a tubular shape, or the center pin extends only to a position near the circular resin-molded product, so that a tip end portion of the injection gate in contact with the circular resin-molded product has a tubular shape, and the remaining portion of the injection gate has a cylindrical columnar shape.

7. A method for manufacturing a circular resin-molded product according to claim 4, wherein the center pin comprises a first center pin used to form the circular resin-molded product, and a second center pin having a diameter greater than that of the first pin and used to form the tubular channel.

8. An apparatus for manufacturing a circular resin-molded product having a circular center hole by means of injecting a molten resin into a mold through an injection gate and cooling and solidifying the injected molten resin,
the mold forming the circular resin-molded product around a center pin having a diameter equivalent to a diameter of the circular center hole,
the center pin axially extending further away from a position corresponding to the circular resin-molded product, whereby the injection gate is constituted by a tubular channel formed by a cylindrical annular clearance formed within the mold around an extended portion of the center pin, and
the molten resin being injected through the injection gate constituted by the tubular channel.

9. An apparatus for manufacturing a circular resin-molded product according to claim 8, wherein the center pin extends to a position near a runner portion through which the molten resin is introduced into the injection gate, so that the entire injection gate has a tubular shape, or the center pin extends only to a position near the circular resin-molded product, so that a tip end portion of the injection gate in contact with the circular resin-molded product has a tubular shape, and the remaining portion of the injection gate has a cylindrical columnar shape.

10. An apparatus for manufacturing a circular resin-molded product according to claim 8, wherein the center pin comprises a first center pin used to form the circular resin-molded product, and a second center pin having a diameter greater than that of the first pin and used to form the tubular channel.
